(19) United States
(12) Patent Application Publication
(10) Pub. No.: US 2006/0142156 A1
(43) Pub. Date: Jun. 29, 2006

(54) Water-immersion indicator indicia and articles bearing such indicia

(75) Inventors: Michael P. Filosa, Medfield, MA (US); Fariza B. Hasan, Waltham, MA (US); Stephen J. Telfer, Arlington, MA (US)

Correspondence Address: POLAROID CORPORATION;PATENT DEPARTMENT, 1265 MAIN STREET, WALTHAM, MA, 02451, US

(73) Assignee: Polaroid Corporation

(21) Appl. No.: 11/364,095

(22) Filed: Feb. 28, 2006

Related U.S. Application Data
(63) Continuation of application No. 10/729,727, filed on Dec. 5, 2003.
(60) Provisional application No. 60/431,569, filed on Dec. 6, 2002.

(51) Int. Cl. C09D 11/00; B41M 5/20

(52) U.S. Cl. 503/200; 106/31.14; 106/31.32; 106/31.64

(57) ABSTRACT

There are described articles bearing indicia applied with an ink composition which comprises two or more color-changing or color-forming components which combine, or become diluted, upon exposure to water for a sufficient period of time to cause a change in the appearance of the indicia. Also described are printing ink compositions for forming such indicia and methods for forming such articles.

### REFERENCE TO RELATED APPLICATION

This application claims the benefit of provisional application Ser. No. 60/431,569 filed Dec. 6, 2002.

### FIELD OF THE INVENTION

The present invention relates generally to an ink composition for indicating the extent of immersion in water of an article bearing indicia formed with the ink, articles such as golf balls bearing indicia formed with the ink and a method for forming such articles.

### BACKGROUND OF THE INVENTION

It is well known to those who play at the sport of golf that great numbers of golf balls are hit into water hazards with the result that these balls may lie submerged in the water for significant periods of time. Because so many golf balls are lost in this manner, it has become profitable to recover the balls and to resell them irrespective of the fact that they may have been in the water for a significant period of time such that the their characteristics may be affected. For example, the characteristics of the ball in flight are typically adversely affected by immersion in water for a significant period of time, for example, a few days or longer.

In view of the foregoing, efforts have been made to determine whether a golf ball has been immersed in water. For example, U.S. Pat. No. 6,358,160 describes a golf ball which changes color or other indicia after significant immersion in water to indicate that the ball has been recovered from a water hazard and may not have predictable flight characteristics which may result in loss of carry and roll. It is taught to make imprints on balls with water-activated ink which vanishes when exposed to water for long periods of time or with water-activated transparent ink which becomes colored and visible when exposed to water for a long period of time. Generally speaking, a distinctive discoloration or indication is provided through the use of water-soluble inks or dyes. Various techniques are disclosed for allowing the water to activate the dye such as, for example, placing the dyes in microcapsules with thin polymer coatings.

There is a continuing need for new color-changing systems for use in ink compositions which are useful as water immersion indicators for articles such as golf balls.

### SUMMARY OF THE INVENTION

It is therefore an object of the invention to provide articles having imprinted thereon ink compositions which are useful as water immersion indicators for the articles.

Another object of the invention is to provide ink compositions which comprise two or more color-changing or color-forming components which are caused to react with each other upon exposure to water for a sufficient period of time.

Another object of the invention is to provide ink compositions which comprise two or more components which together form color, the degree of color formed depending upon the concentration of each component and wherein dilution of the ink composition by water changes the concentration of at least one component and thereby leads to a change in the color of the ink.

It is another object of the invention to provide golf balls having such ink compositions imprinted thereon.

A further object of the invention is to provide articles having imprinted thereon ink compositions which change color when activated by water.

Another object of the invention is to provide articles having imprinted thereon colorless ink compositions which become colored when activated by water.

Yet another object of the invention is to provide articles having imprinted thereon colored ink compositions which become at least substantially colorless when activated by water.

Another object is to provide methods for forming articles according to the invention.

Still another object of the invention is to provide novel ink compositions which are useful as water immersion indicators when applied to articles.

These and other objects and advantages are attained in accordance with the invention by providing novel water-activated ink compositions which comprise two or more color-changing or color-forming components which combine upon exposure to water, or become diluted upon exposure to water, for a sufficient period of time to change the color of the ink or to cause the ink to change from colored to substantially colorless or colorless or to cause the ink to change from colorless to colored. At least one of the two or more components has sufficient solubility or diffusibility in water to cause the desired change in the ink to occur. The ink compositions of the invention include the two or more components described above dispersed or dissolved in a fluid carrier, which typically is an organic solvent. The ink compositions of the invention preferably also include a binder material, which may be a polymeric material.

The ink compositions of the invention may be prepared by methods which are known in the art and may be imprinted on articles such as golf balls by methods which are known in the art.

Preferred ink compositions according to the invention are those comprising: a) an acid-sensitive indicator dye and a water-soluble or diffusible acid; b) an acid-sensitive, water-soluble or diffusible dye and an acid; c) a water-soluble or diffusible, base-sensitive indicator dye and a base; and d) a base sensitive indicator dye and a water-soluble or diffusible base.

### BRIEF DESCRIPTION OF THE DRAWINGS

For a better understanding of the invention as well as other objects and further features thereof, reference is made to the following detailed description of various preferred embodiments thereof taken in conjunction with the accompanying drawings wherein:

FIG. 1 is a graphical representation of the results obtained from an experiment wherein varying levels of the components of an ink composition of the invention were used;

FIG. 2 is a graphical representation of the results obtained from the experiment with an ink composition according to the invention which is described in Example II; and

FIG. 3 is a graphical representation of the results obtained from the experiment with another ink composition according to the invention which is described in Example III.

### DESCRIPTION OF THE PREFERRED EMBODIMENTS

As discussed previously, generally, the ink compositions of the invention comprise at least two color-changing or color-forming components which combine upon exposure to water for a sufficient period of time to change the color of the ink or to cause the ink to change from colored to substantially colorless or colorless or to cause the ink to change from colorless to colored. At least one of the two components has sufficient solubility or diffusibility in water to cause the desired change in the ink to occur. The ink composition preferably also includes a binder material. Any binder material which is soluble in organic solvents may be utilized. Typical suitable binder materials include polymeric materials such as poly (vinyl acetate), poly (vinyl butyraldehyde), acrylates, nitrocellulose and the like.

The ink compositions of the invention, upon exposure to water, for a sufficient period of time, may undergo a change in color such as from one color to another, or from colored to substantially colorless or colorless or from colorless to colored. The terms “color-change” and “color-forming”, as used throughout the application including in the claims, include all such embodiments.

Any combination of materials that may be caused to undergo a color change or to form a color, upon exposure to water for a sufficient period of time may be used. The materials may react chemically upon exposure to water, either as a result of being brought together by a physical mechanism, such as dissolution or diffusion, or through acceleration of a reaction rate. The reaction may be chemically reversible or irreversible.

Alternatively, the components may form an amount of color that depends upon their concentration in the ink. For example, the higher the concentration of a weak acid in association with an acid-sensitive leuco dye that changes appearance from colorless to colored in the presence of acid, the greater the amount of the colored form of the leuco dye. The ink composition of the present invention may comprise such a combination. Provided that at least one of the color-forming components of the ink formulation is soluble in water, addition of water will dilute the ink formulation, changing the concentration of at least that one component. This change in the concentration of at least one of the components of the ink formulation will lead to a change in the color of the ink. Moreover, depending upon the equilibrium constant for formation of color from the ink components, the change in color of the ink may be much greater than would be achievable simply from dilution of a single-component dye material.

In the case where addition of water brings at least two components together such that they react and change color, it is desirable that the ink composition comprise a dispersion of the components in a solvent that does not dissolve the components. In the alternative case where, in the ink formulation, the components are already in association with each other, and addition of water serves to dilute the composition and thereby change its color, it is desirable that the ink formulation be a solution of the components in a solvent in which they are both (or all) soluble.

Various chemical mechanisms suitable for practicing either variant of the present invention may be utilized. A colorless dye precursor may form color upon water-induced contact with a reagent, or may be coated in association with the reagent and thereafter be diluted by water. This reagent may be a Bronsted acid, as described in “Imaging Processes and Materials”, Neblette's Eighth Edition, J. Sturge, V. Walworth, A. Shepp, Eds., Van Nostrand Reinhold, 1989, pp. 274-275, or a Lewis acid, as described for example in U.S. Pat. No. 4,636,819. Suitable dye precursors for use with acidic reagents are described, for example, in U.S. Pat. No. 2,417,897, South African Patent 68-00170, South African Patent 68-00323 and Ger. Offen. 2,259,409. Further examples of such dyes may be found in “Synthesis and Properties of Phthalide-type Color Formers”, by Ina Fletcher and Rudolf Zink, in “Chemistry and Applications of Leuco Dyes”, Muthyala Ed., Plenum Press, New York, 1997. Such dyes may comprise a triarylmethane, diphenylmethane, xanthene, thiazine or spiro compound, for example, Crystal Violet Lactone, N-halophenyl leuco Auramine, rhodamine B anilinolactam, 3-piperidino-6-methyl-7-anilinofluoran, benzoyl leuco Methylene blue, 3-methyl-spirodinaphthofuran, etc. The acidic material may be a phenol derivative or an aromatic carboxylic acid derivative, for example, p-tert-butylphenol, 2,2-bis (p-hydroxyphenyl)propane, 1,1-bis(p-hydroxyphenyl) pentane, p-hydroxybenzoic acid, 3,5-di-tert-butylsalicylic acid, etc. Such materials and various combinations thereof are now well known. For example, thermal imaging elements employing these materials are well known and have been described, for example, in U.S. Pat. Nos. 3,539,375, 4,401,717 and 4,415,633.

The reagent used to form a colored dye from a colorless precursor may also be an electrophile, as described, for example, in U.S. Pat. No. 4,745,046, a base, as described, for example, in U.S. Pat. No. 4,020,232, a chelatable agent, as described, for example, in U.S. Pat. No. 3,293,055 for spiropyran dyes, or a metal ion, as described, for example, in U.S. Pat. No. 5,196,297 in which thiolactone dyes form a complex with a silver salt to produce a colored species.

The reverse reaction, in which a colored material is rendered colorless by the action of a reagent, may also be used. Thus, for example, a protonated indicator dye may be rendered colorless by the action of a base, or a preformed dye may be irreversibly decolorized by the action of a base, as described, for example, in U.S. Pat. Nos. 4,290,951 and 4,290,955, or an electrophilic dye may be bleached by the action of a nucleophile, as described in U.S. Pat. No. 5,258,274.

Reactions such as those described above may also be used to convert a molecule from one colored form to another form having a different color.

The reagents used in schemes such as those described above may be sequestered from the dye precursor and brought into contact with the dye precursor by the action of water or alternatively a chemical precursor to the reagents themselves may be used. The precursor to the reagent may be in intimate contact with the dye precursor. The action of water may be used to release the reagent from the reagent precursor. Many protecting/triggering groups are sensitive to water and those skilled in the art will be able to select appropriate hydrolytically-sensitive groups for use in accordance with the invention. See, for example, T. H. Greene et al., Protective Groups In Organic Synthesis, John Wiley and Sons.

Yet another chemical color change method involves a unimolecular reaction, which may form color from a colorless precursor, cause a change in the color of a colored material, or bleach a colored material. The rate of such a reaction may be accelerated by water.

It is not necessary that the colored material formed be a dye. The colored species may also be, for example, a species such as a metal or a polymer. U.S. Pat. No. 3,107,174 describes the thermal formation of metallic silver (which appears black) through reduction of a colorless silver behenate salt by a suitable reducing agent.

Any suitable dye may be incorporated in the ink compositions of the invention. Acid-sensitive leuco dyes comprise a preferred class of dyes. Typical suitable acid-sensitive leuco dyes include Copikem 34, available from Hilton-Davis Company.

In the embodiment of the invention in which water serves to dilute a composition comprising at least two components in association with each other, any suitable organic or inorganic acid which results in coloration of a leuco dye may be used. Addition of water changes the concentration of acid and, possibly, leuco dye, and thereby changes the equilibrium between colored and colorless forms of the leuco dye. Typical suitable acids include hydroxybenzoic acid, polyhydroxybenzoic acids such as 2,6-dihydroxybenzoic acid, phenols, strong organic acids such as, for example, p-toluene sulfonic acid, and sulfinic acids, salicyclic acid, citric acid and the like. Generally, weak organic acids are preferred.

Mixtures of dyes and mixtures of acids may be utilized. In these embodiments the colors and the fading rates of the indicia may be adjusted as desired.

The ink compositions of the invention preferably include a binder material which may be a polymeric material. Typical suitable binder materials include solvent-soluble polymeric materials used in inks and paints. Suitable binder materials include poly (vinyl acetate), poly (vinyl butyraldehyde), acrylates, nitrocellulose and the like.

A preferred ink-composition according to the invention comprises from about 2.5 to about 5% (by weight) of an acid-sensitive leuco dye (Copikem 34), from about 2.5 to about 5% of 2,6-dihydroxybenzoic acid and from about 2.5 to about 5% of poly (vinyl acetate).

In order to be imprinted on an article such as a golf ball the ink composition is dispersed or dissolved in a suitable fluid carrier which is typically an organic solvent. Typical suitable carrier fluid include organic solvents such as, acetates, e.g., butyl acetate, alcohols, e.g., ethanol, butanol and 2-propanol, ketones, e.g., methyl ethyl ketone and cyclohexanone.

As described previously, the ink compositions of the invention are caused to undergo a color change or to form a color upon exposure to water for a sufficient period of time. The time period which is sufficient for any specific ink composition to undergo a desired color change or color formation is variable and can be designed to be a few days or longer. Generally, the ink components should not combine so as to result in a color-change, or be diluted so as to lead to a color change, during normal washing of the articles or during hot or humid conditions. Preferably, the indicia formed with the ink compositions of the invention should be substantially stable for up to about 24 hours of exposure to water and then undergo the desired color-change over a period of about one month of exposure to water.

As is known in the art, golf balls typically include a glossy outer layer of a material such as a polyurethane or a polyester. A typical outer layer material for golf balls is Surlyn®, an ionomer blend. Typically indicia such as the brand name of the ball are imprinted on the ball with an ink composition according to the invention prior to applying the outer layer. The ink compositions of the invention are dissolved or dispersed in a fluid carrier and the solution or dispersion then used to imprint indicia on the articles such as by stamping the indicia on the articles with automatic stamping apparatus.

### EXAMPLES

The invention will now be described further with respect to specific preferred embodiments by way of examples, it being understood that these are intended to be illustrative only and the invention is not limited to the materials, amounts, procedures and process parameters, etc. recited therein. All parts and percentages are by weight unless otherwise specified.

### Example I

A factorial experiment was performed to assess the sensitivity of fading of a black disappearing ink made from Copikem 34 (BFGoodrich, Hilton-Davis Company), 2,6-dihydroxybenzoic acid, and polyvinyl acetate as binder. A high level (+) and a low level (−) was used of each variable. The eight possible combinations of levels are described in Table 1. The coating fluids were prepared according to Table 1. The requisite amount of dye (50 mg or 25 mg) and the requisite amount of acid were weighed into a two dram vial. The requisite amount of poly (vinyl acetate) was added as a 10% solution in methyl ethyl ketone (MEK). Additional MEK was then added to bring the total weight of the fluid to 1.0 gram. Eight such fluids were prepared using the ratios of ingredients described in Table 1.

Each black ink fluid was then coated in a thin film using a #16 Meyer rod onto a 2 inch by 3.5 inch, injection-molded, white Surlyn plaque. The plaque was air dried until it was not tacky and then placed in a 60° C. oven for 15 minutes. The dried plaques were then overcoated with a two-part high gloss urethane composition (PD300185A urethane base, PD300185B urethane activator available from, Akzo-Nobel Specialty Coatings, Waukegan, Ill.). The urethane components were combined in a one to one ratio and coated in a thin film using a #21 Meyer rod. After air and oven drying the reflection optical densities were measured using an X-rite densitometer. These values are listed in Table 2 as time equal to zero. The point of measurement was marked and all subsequent measurements were taken in the same place.

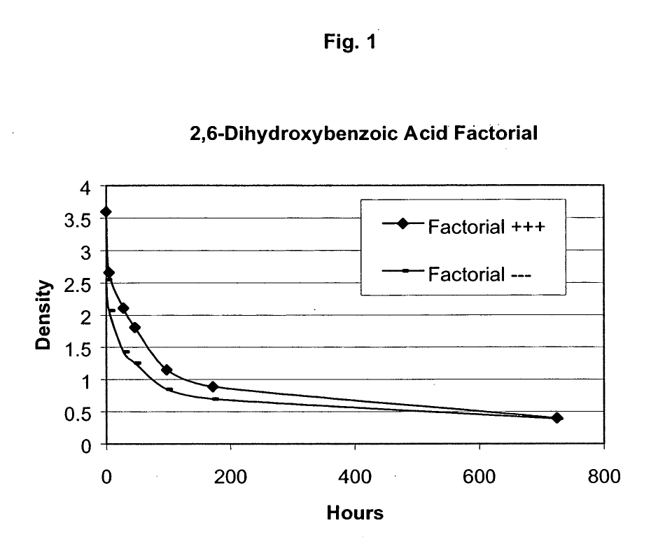

Each inked and overcoated plaque was then placed in a rectangular tank filled to approximately 3 inches with tap water. The plaques were placed in the tank under ambient conditions and the tank was sealed. The plaques were removed at various time intervals as described in Table 2 and the loss of reflection density was recorded. These results over a 30 day period are summarized in Table 2. In all cases substantial fading from above 2.5 density to approximately 0.5 density was observed. FIG. 1 is a graphical illustration of fading for the two most extreme experiments; experiment 1 with high levels of all components and experiment 8 with low levels of all components. The results illustrate that in an environment similar to that of a golf ball submerged in a water hazard, this ink formulation according to the invention fades nearly completely.

TABLE 1

| | | | Polyvinyl | |
|---|---|---|---|---|
| Experiment | Acid | Dye | acetate | Sample Code |
| 1 | 50 mg | 50 mg | 50 mg | (+, +, +) |
| 2 | 50 mg | 50 mg | 25 mg | (+, +, −) |
| 3 | 50 mg | 25 mg | 50 mg | (+, −, +) |
| 4 | 50 mg | 25 mg | 25 mg | (+, −, −) |
| 5 | 25 mg | 50 mg | 50 mg | (−, +, +) |
| 6 | 25 mg | 50 mg | 25 mg | (−, +, −) |
| 7 | 25 mg | 25 mg | 50 mg | (−, −, +) |
| 8 | 25 mg | 25 mg | 25 mg | (−, −, −) |

TABLE 2
Fading of Copikem 34 and 2,6-Dihydroxybenzoic acid
Factorial Experiment with 2,6-dihydroxybenzoic Acid
(Decrease in Optical Density vs. Time)

| | | Time (hrs) | | | | | | | |
|---|---|---|---|---|---|---|---|---|---|
| | Experiment | 0 | 4.5 | 27.5 | 46 | 97 | 171.5 | 724 | 1600 |
| Density | 1 (+, +, +) | 3.6 | 2.66 | 2.11 | 1.81 | 1.15 | 0.89 | 0.4 | 0.28 |
| | 2 (+, +, −) | 3.11 | 2.61 | 2.13 | 1.83 | 1.37 | 0.99 | 0.5 | 0.31 |
| | 3 (+, −, +) | 2.86 | 2.2 | 1.62 | 1.35 | 0.9 | 0.73 | 0.42 | 0.33 |
| | 4 (+, −, −) | 2.81 | 2.3 | 1.67 | 1.36 | 0.92 | 0.76 | 0.5 | 0.38 |
| | 5 (−, +, +) | 3.76 | 3.4 | 2.84 | 2.73 | 2.01 | 1.54 | 0.6 | 0.38 |
| | 6 (−, +, −) | 3.14 | 2.62 | 1.93 | 1.66 | 1.22 | 0.89 | 0.43 | 0.26 |
| | 7 (−, −, +) | 3.1 | 2.66 | 2.04 | 1.66 | 0.99 | 0.86 | 0.4 | 0.29 |
| | 8 (−, −, −) | 2.55 | 2.07 | 1.43 | 1.26 | 0.85 | 0.7 | 0.39 | 0.27 |

The results from experiments 1 and 8, the two most extreme ink compositions in terms of amounts of the components are illustrated graphically in FIG. 1. It is seen that the initial density and the rate of fading in water are influenced by the amount of the components in the composition. The change in density for each ink composition was visually apparent in about four days.

### Example II

Copikem 34 (50 mg), citric acid (50 mg) and poly (vinyl acetate) (100 mg) were combined in methyl ethyl ketone and the weight adjusted to 1.0 gm to produce a black fluid. The citric acid was only slightly soluble in this mixture. Black coatings were made on Surlyn chips (approximately 2″×3.5″) as described in Example I. The black ink coating was then overcoated with the high gloss two part urethane product of AKZO Nobel described in Example I. Application of the urethane caused the color to fade but upon drying some of the color came back. The chips were then placed in room temperature water and monitored over approximately a period of one week.

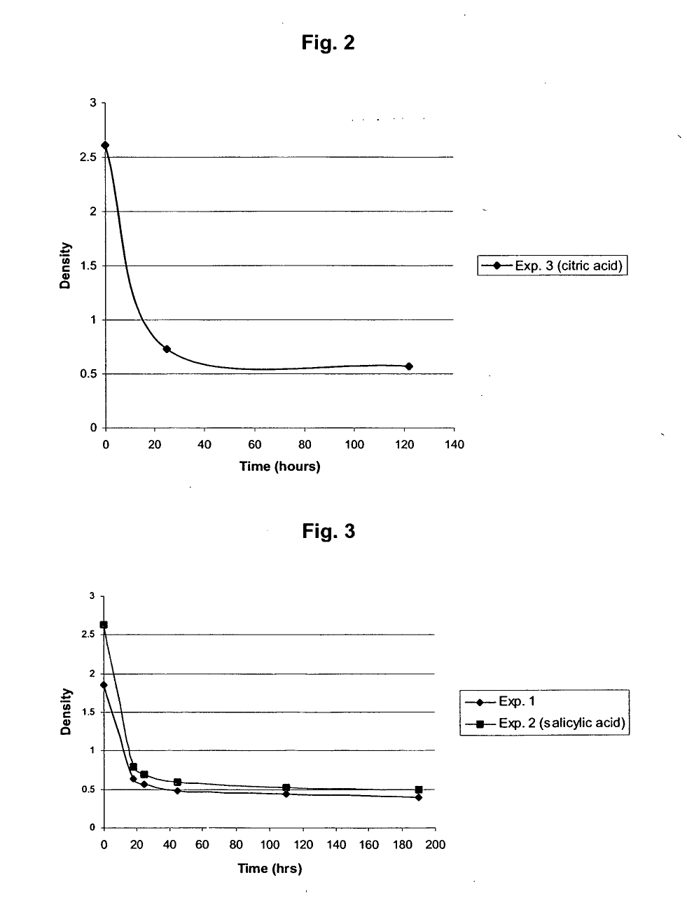

The initial color faded significantly from a Dmax of 2.5 to a Dmin of 0.5 after about one day of exposure to water. See FIG. 2.

### Example III

Salicylic acid (100 mg) was dissolved in a mixture of Copikem 34 (100 mg) in 10% poly(vinyl acetate) (100 mg PVAc), all in methyl ethyl ketone (total weight of 1.0 gm to form an intense black fluid which coated very well on Surlyn chips to produce optical densities above 3. When the urethane overcoating described in Example was applied the black color faded almost completely away and partially came back on drying. It was found that by using a high level of acid (about 100 mg)) and binder (100 mg PvAc), a density of approximately 2.5 could be maintained. When exposed to water as described in Example I the initial Dmax of 2.5 dropped to approximately 0.5 (see FIG. 3).

Although the invention has been described in detail with respect to various preferred embodiments, it is not intended to be limited thereto, but rather those skilled in the art will recognize that variations and modifications are possible which are within the spirit of the invention and the scope of the appended claims.

1. An indicia-bearing article, said indicia comprising an ink composition comprising two or more color-forming components which cause a change in the appearance of the indicia upon exposure to water for a sufficient period of time, wherein one of said color-forming components is an acid-sensitive leuco dye and the other of said components is an acid developer, and wherein said indicia are initially colored.

2. The article according to claim 1 which is a golf ball.

3. (canceled)

4. The article according to claim 2 wherein said indicia change to another color upon exposure to water for a sufficient period of time.

5. (canceled)

6. The article as defined in claim 2 wherein said indicia become colorless or substantially colorless upon exposure to water for a sufficient period of time.

7. (canceled)

8. (canceled)

9. (canceled)

10. (canceled)

11. A method for forming an indicia-bearing article comprising imprinting on an article indicia comprising an ink composition comprising two or more color-forming components which cause a change in the appearance of the indicia upon exposure to water for a sufficient period of time, wherein one of said color-forming components is an acid-sensitive leuco dye and the other of said components is an acid developer, and wherein said indicia are initially colored.

12. The method as defined in claim 11 wherein said ink composition comprises said two or more components in an organic solvent.

13. The method as defined in claim 12 wherein said ink composition further includes a binder material.

14. The method as defined in claim 11 wherein said article is a golf ball.

15. (canceled)

16. The method as defined in claim 14 wherein said indicia change to another color upon exposure to water for a sufficient period of time.

17. The method as defined in claim 14 wherein said indicia become substantially colorless or colorless upon exposure to water for a sufficient period of time.

18-28. (canceled)
